(19) United States
(12) Patent Application Publication
(10) Pub. No.: US 2016/0314486 A1
(43) Pub. Date: Oct. 27, 2016

(54) METHOD AND SYSTEM FOR STORAGE DEVICES WITH PARTNER INCENTIVES

(71) Applicant: Hubbert SMITH, Sandy, UT (US)

(72) Inventor: Hubbert SMITH, Sandy, UT (US)

(21) Appl. No.: 14/868,372

(22) Filed: Sep. 28, 2015

Related U.S. Application Data
(60) Provisional application No. 62/151,082, filed on Apr. 22, 2015.

(51) Int. Cl. G06Q 30/02; G06Q 30/00

(52) U.S. Cl. CPC G06Q 30/0207; G06Q 30/0185

(57) ABSTRACT

A device (205, 425, 440) can include a storage device (210), such as a Solid State Drive (SSD). The storage device (210) can store a partner ID (215, 220) identifying a partner (105) that deployed the device (205, 425, 440) to a customer (125). A metrics capture module (230) in the device (205, 425, 440) can capture metrics (435, 445, 605) about the operation of the storage device (210). A transmitter (235) in the device (205, 425, 440) can transmit the metrics (435, 445, 605) to the manufacturer (110) of the device (205, 425, 440), potentially via an aggregator (135). The manufacturer (110) of the device (205, 425, 440) can use the metrics (435, 445, 605) and the partner ID (215, 220) to provide an incentive (725, 810, 820, 825) the partner (105).

### RELATED APPLICATION DATA

This application claims the benefit of U.S. Provisional Patent Application Ser. No. 62/151,082, filed Apr. 22, 2015, which is hereby incorporated by reference for all purposes.

### FIELD

The inventive concept pertains to storage devices, and more particularly to storage devices that can provide information about the operation of the storage devices.

### BACKGROUND

Enterprise storage systems are complex and challenging to deploy: end-customers typically rely on software partners and implementation partners. These partners are the authority for hardware selection, and they most often select the cheapest hardware. To these key partners, storage devices are a commodity. Price-capacity is the only consideration.

Manufacturers have their own concerns about their products. Manufacturers want end-customers to use the optimum hardware, which oftentimes is more expensive than the cheapest hardware available. Manufacturers are also concerned that their products are used as expected. If a product is sold on the grey market, this sale can undercut the manufacturer's profit margins. A need remains for a way to both incentivize partners to consider factors other than price or capacity in selecting hardware for deployment at end-customer facilities, and to track and prevent grey market leakage for manufacturers.

### BRIEF DESCRIPTION OF THE DRAWINGS

FIG. 1 shows a sequence of events involving a partner, a customer, an aggregator, and a manufacturer, according to an embodiment of the inventive concept.

FIG. 2 shows a device that can report metrics back to the manufacturer of FIG. 1.

FIG. 3 shows examples of metrics that can be reported by the device of FIG. 2.

FIG. 4 shows a server acting as the aggregator of FIG. 1, according to an embodiment of the inventive concept.

FIG. 5 shows the RAID controller of FIG. 4 instructing devices such as the devices of FIGS. 2 and 4 when to report metrics back to the manufacturer of FIG. 1 or the aggregator of FIGS. 1 and 4.

FIG. 6 shows the aggregator of FIGS. 1 and 4 aggregating metrics from various devices before reporting the metrics to the manufacturer of FIG. 1.

FIG. 7 shows a server acting as the manufacturer of FIG. 1, according to an embodiment of the inventive concept.

FIG. 8 shows how the manufacturer of FIG. 1 can use the aggregated metrics of FIG. 6 to determine whether a partner qualifies for an incentive.

FIGS. 9A-9B show a flowchart of a procedure for the devices of FIGS. 2 and 4 to collect and report metrics to the manufacturer of FIG. 1, according to an embodiment of the inventive concept.

FIG. 10 shows a flowchart of a procedure for the aggregator of FIGS. 1 and 4 to aggregate metrics from various devices and report the aggregated metrics to the manufacturer of FIG. 1, according to an embodiment of the inventive concept.

FIGS. 11A-11C show a flowchart of a procedure for the manufacturer of FIG. 1 to mine the metrics from the devices of FIGS. 2 and 4 to determine whether a partner qualifies for an incentive, according to an embodiment of the inventive concept.

FIG. 12 shows a flowchart of a procedure for the manufacturer of FIG. 1 to address a device that has entered the grey market, according to an embodiment of the inventive concept.

### DETAILED DESCRIPTION

Reference will now be made in detail to embodiments of the inventive concept, examples of which are illustrated in the accompanying drawings. In the following detailed description, numerous specific details are set forth to enable a thorough understanding of the inventive concept. It should be understood, however, that persons having ordinary skill in the art may practice the inventive concept without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first module could be termed a second module, and, similarly, a second module could be termed a first module, without departing from the scope of the inventive concept.

The terminology used in the description of the inventive concept herein is for the purpose of describing particular embodiments only and is not intended to be limiting of the inventive concept. As used in the description of the inventive concept and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The components and features of the drawings are not necessarily drawn to scale.

To encourage partners to select devices using criteria other than price, and to be able to track devices sold on the grey market, manufacturers can use embodiments of the inventive concept to review which partners deployed the devices to their customers, and to determine if a device has entered the grey market. Partners can be offered incentives in various ways: for example, to use particular devices in deployments to customers. Metrics received from the devices can be analyzed by the manufacturer to determine what devices have been deployed to the customer and how the customer has utilized the devices. This information can be used to determine where the partner has satisfied the objectives of an incentive program, analogous to a frequent-flier program. The metrics can also be analyzed to determine whether the customer's devices might require any preventative maintenance: for example, an update to the firmware, or replace a device. And the manufacturer can use information about the devices, customers, and partners to ensure that the device did not enter the grey market.

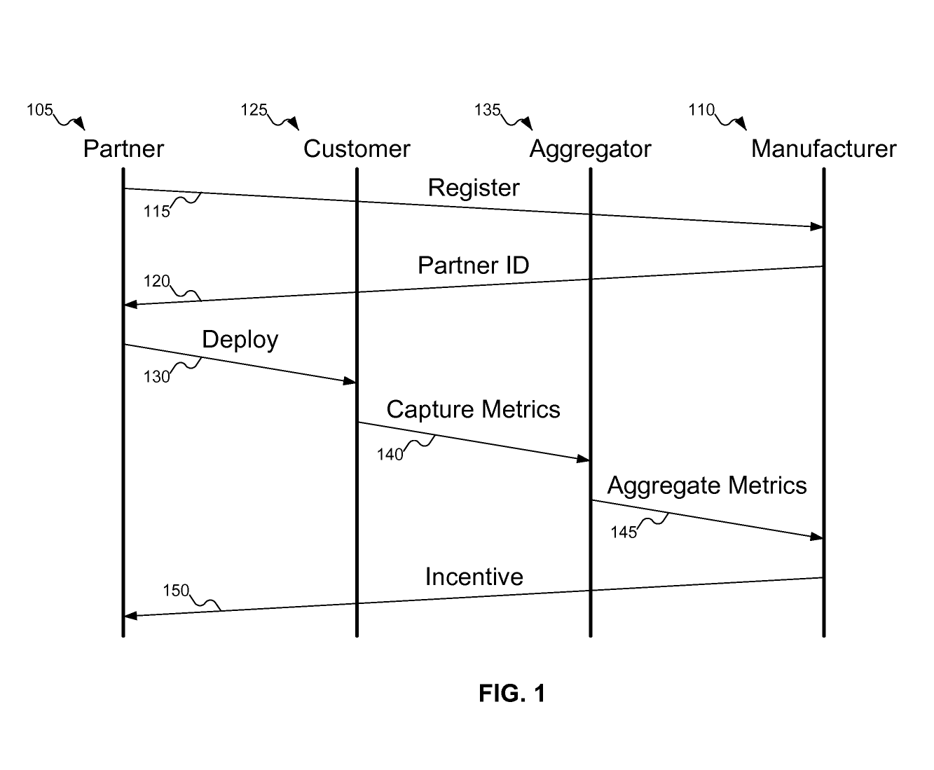

FIG. 1 shows a sequence of events involving a partner, a customer, an aggregator, and a manufacturer, according to an embodiment of the inventive concept. In FIG. 1, partner 105 can start by registering with manufacturer 110, as shown by arrow 115. Manufacturer 110 can return a partner ID to partner 105, as shown by arrow 120. Partner 105 can then use the partner ID in deployments to customers.

When partner 105 deploys an installation at customer 125, as shown by arrow 130, partner 105 can store the partner ID in devices during deployment. This can be done in a number of ways: for example, partner 105 can use a provisioning script to store the partner ID in the device. Then, the device can periodically report metrics to aggregator 135, as shown by arrow 140. As described below, aggregator 135 can be a software agent running within the network of customer 105: for example, on a server within the network of customer 105. Aggregator 135 can collect metrics from multiple devices deployed at customer 125 and report the aggregated metrics back to manufacturer 110, as shown by arrow 145. Alternatively, aggregator 135 can be external to customer 105 or can be omitted entirely, and the device can report directly back to manufacturer 110. Regardless of how manufacturer 110 receives the metrics, manufacturer 110 can use the information to compensate partner 105 as per an incentive, as shown by arrow 150.

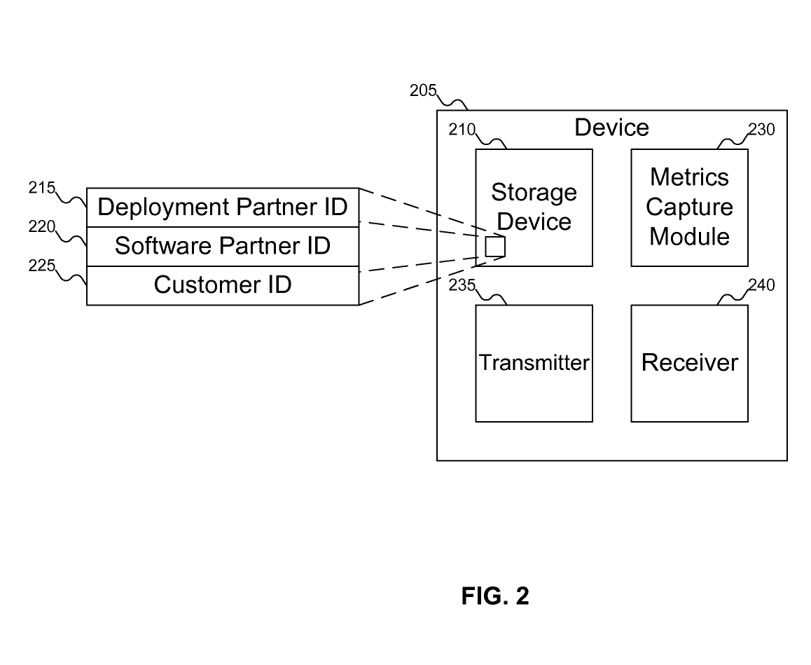

FIG. 2 shows a device according to an embodiment of the inventive concept that can report metrics back to manufacturer 110 of FIG. 1. Device 205 can be a device offered by manufacturer 110. Device 205 can include storage device 210. Storage device 210 can be any type of storage device, such as a Solid State Drive (SSD), Hard Disk Drive (HDD), Non-Volatile Memory (NVM), Random Access Memory (RAM), and so on. Storage device 210 can include storage for identifiers, such a Deployment Partner ID 215, Software Partner ID 220, and Customer ID 225. Deployment Partner ID 215 can identify which partner 105 performed the deployment at customer 125. Software Partner ID 220 can identify which partner 105 was responsible for any software installed at customer 125. And Customer ID 225 can identify customer 125 for whom the deployment was done.

In addition to storage device 210, device 205 can include metrics capture module 230, transmitter 235, and receiver 240. Metrics capture module 230 can capture various metrics about storage device 210. Metrics capture module 230 can be implemented as software that can be running on, for example, a processor within device 205 or storage device 210, but a person skilled in the art will recognize that metrics capture module 230 can also be implemented as special-purpose hardware within device 205, or even be a separate component connected to device 205 that can capture metrics about storage device 210. Transmitter 235 and receiver 240 can each be various standard interconnects communicating with other portions of a standard computer system. Transmitter 235 can transmit the captured metrics, either to aggregator 135 or manufacturer 110, as appropriate. And receiver 240 can receive information from other components. For example, receiver 240 can be used to receive a signal from a Redundant Array of Independent Disks (RAID) controller. The RAID controller can signal device 205 when to report metrics to aggregator 135. In this manner, the RAID controller can signal devices such as device 205 to report their captured metrics in a manner that minimizes the downtime of devices to customer 125. More specifically, by signaling one device at a time to report is captured metrics to aggregator 135, the overall RAID appears to be operating all the time, since the other disks can continue to respond to requests from customer 125. Device 205 can use transmitter 235 to transmit the captured metrics to aggregator 135 on any desired schedule: for example, once every second.

Although FIG. 2 suggests that storage device 210 can be physically distinct from device 205 (for example, in the sense that device 205 can physically encapsulate storage device 210), such is not necessarily the case. For example, device 205 can be an SSD or a HDD in its enclosure, which already has transmitter 235 and receiver 240 included. Metrics capture module 230 can then be software or commands in some other form, such as encoded in a Read-Only Memory (ROM) or other chip installed within storage device 210, which can capture the metrics of storage device 210.

In one embodiment of the inventive concept, device 205 can be installed in a traditional computer system or server at customer 125. In a second embodiment of the inventive concept, device 205 can be installed in a smart phone. In a third embodiment of the inventive concept, device 205 can be installed in a tablet computer. In a fourth embodiment of the inventive concept, device 205 can be installed in a network device. In a fifth embodiment of the inventive concept, device 205 can be installed in a smart TV. Other embodiments of the inventive concept can include various combinations of these installations for different devices 205.

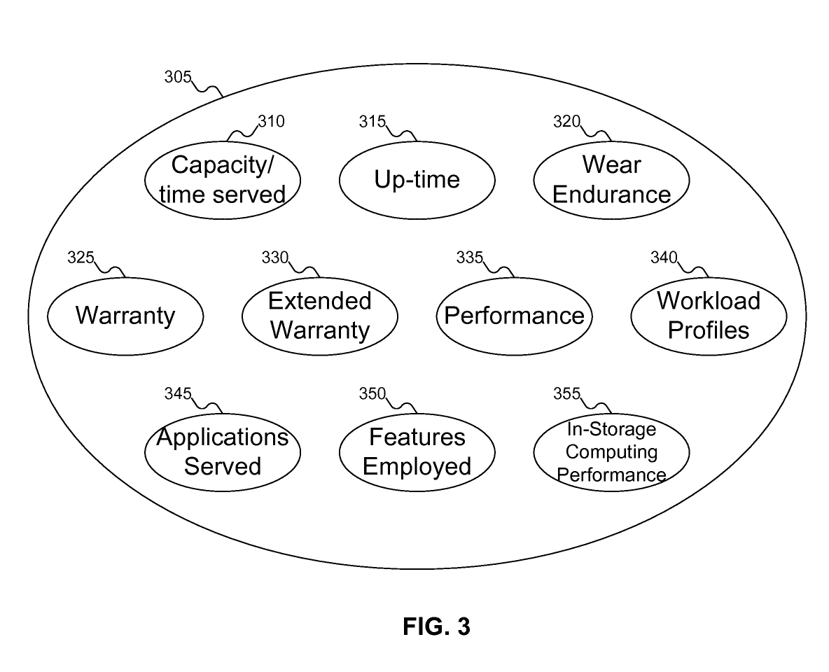

FIG. 3 shows example metrics 305 that can be reported by device 205 of FIG. 2. Metrics 305 can include the following exemplary metrics:
Capacity/time served (metric 310): this metric can measure how much data (for example, how many terabytes (TB) of data) is written to and/or read from storage device 210 during a given week.
Up-time (metric 315): this metric can measure how much time storage device 210 is operating and available for use by customer 125. Up-time (metric 315) can be measured as a percentage of actual time (e.g., storage device 210 is up 95% of the time), or up-time (metric 315) can measure the actual time that storage device 210 is up during a given interval of time (e.g., storage device 210 was up for 160 hours during the past week).
Wear endurance (metric 320): this metric can measure how well storage device 210 is doing relative to its expected lifetime. For example, SSDs have an expected number of write operations, after which the storage starts to become unreliable. Wear endurance (metric 320) can track the number of writes to an SSD. As another example of wear endurance (metric 320), this metric can count the number of soft errors detected in storage device 210.
Warranty (metric 325) and Extended warranty (metric 330): these metrics can measure how much time remains under the manufacturer's warranty and an extended warranty for storage device 210.
Performance (metric 335): this metric can measure, relative to its up-time (metric 315), how much time storage device 210 has been used to actively write and/or read data. Performance (metric 335) can be measured relative to the original deployment of storage device 210 or relative to a particular window of time (for example, the past week).
Workload profiles (metric 340): this metric can measure the relative operation of storage device 210. For example, a workload profile (metric 340) can measure, among other possibilities, how many operations were write operations v. read operations, how many operations were on large blocks v. small blocks, and how many operations involved random access to storage device 210 v. sequential access. These metrics can be of particular interest in determining whether a software partner has completed an incentive. Workload profiles (metric 340) can be measured relative to the original deployment of storage device 210 or relative to a particular window of time (for example, the past week).
Applications served (metric 345): this metric can measure which applications have accessed storage device 210, and their relative use of storage device 210 (for example, to identify that one application has used 40% of the performance of storage device 210, whereas another application has used only 10% of the performance of storage device 210). Applications served (metric 345) can be measured relative to the original deployment of storage device 210 or relative to a particular window of time (for example, the past week).
Features employed (metric 350): this metric can track which features (functionality beyond simple read/write access) of storage device 210 have been employed. Examples of features that can be employed include Multi-Stream (an enhanced garbage collection approach offered by Samsung Electronics Co., Ltd.), which can be included within the firmware of storage device 210, and in-storage computing. Features employed (metric 350) can be measured relative to the original deployment of storage device 210 or relative to a particular window of time (for example, the past week).
In-storage computing performance (metric 355): this metric can track the use of in-storage processors, which can relieve some of the processing burden on a central processing unit by performing processing within storage device 210 on data stored within storage device 210. Examples of In-storage computing performance (metric 355) that can be tracked include how much data was processed using in-storage computing, how many queries were processed using in-storage computing, and how much latency was experienced using in-storage computing. In-storage computing performance (metric 355) can also be thought of as an example of a feature of storage device 210, and therefore an example of metric 355. In-Storage computing performance (metric 355) can be measured relative to the original deployment of storage device 210 or relative to a particular window of time (for example, the past week).

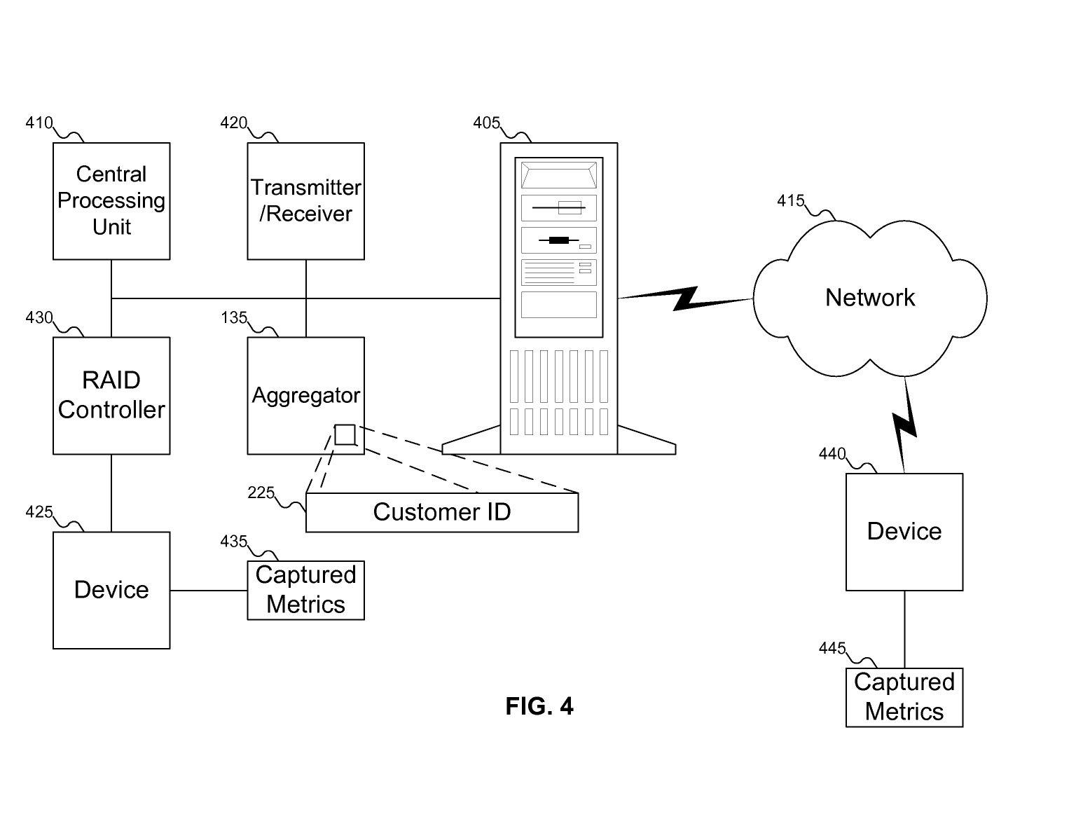

FIG. 4 shows a server acting as the aggregator of FIG. 1, according to an embodiment of the inventive concept. In FIG. 4, server 405 is shown. A person skilled in the art will recognize that other components not shown can be attached to server 405: for example, other input/output devices, such as a monitor, keyboard, mouse, and/or printer, can be included. In addition, server 405 can include conventional internal components such as central processing unit 410, memory, network adapter, and so on. A person skilled in the art will recognize that server 405 can interact with other servers and/or computer systems, either directly or over a network, such as network 415, which be any type of network: for example, Local Area Network (LAN), Wide Area Network (WAN), Virtual Private Network (VPN), or Internet. In addition, although FIG. 4 shows only one network 415, which is intended to represent a LAN or WAN, a person skilled in the art will recognize that server 405 can be connected to any number of networks, each network being of the same or different type. To enable communication over network 415, server 405 can include transmitter/receiver 420, which can transmit and receive data. Finally, although FIG. 4 shows server 405 as a conventional server, a person skilled in the art will recognize that server 405 can be any type of machine or computing device, including, for example, a desktop computer, a laptop computer, a tablet computer, a personal digital assistant (PDA), or a smart phone, among other possibilities.

Server 405 can also include devices, such as device 425, which can be a device like device 205 of FIG. 2. In FIG. 4, device 425 is shown connected to RAID controller 430: thus, device 425 is merely exemplary of the various devices that could be connected to server 405 via RAID controller 430. In addition, while FIG. 4 shows device 425 connected to server 405 via RAID controller 430, a person skilled in the art will recognize that server 405 can also include devices that are not part of the RAID, or are part of an additional RAID.

As a device such as device 205 of FIG. 2, device 425 can capture metrics using metrics capture module 230 of FIG. 2. These metrics are shown as captured metrics 435. As described above, captured metrics 435 can be reported directly to manufacturer 110 of FIG. 1, or they can be reported to aggregator 135, which can aggregate metrics from various devices into a report that can then be sent to manufacturer 110 of FIG. 1. Aggregator 135 can be implemented as software running on server 405, but a person skilled in the art will recognize that aggregator 135 can also be implemented as a special-purpose machine that can be connected to server 405, or can be included within devices 205, 425, and 440, among other possibilities.

Aggregator 135 can include Customer ID 225. In embodiments of the inventive concept where aggregator 135 is used, all the devices (such as devices 205, 425, and 440) deployed to a customer can report to aggregator 135 within the internal network of customer 125 of FIG. 1. Since all the devices are internal to customer 125 of FIG. 1 and report captured metrics 435 to aggregator 135, the devices do not need to store Customer ID 225. Instead, aggregator 135 can store Customer ID 225, and can include Customer ID 225 in the report to manufacturer 110 of FIG. 1. In contrast, note that devices 425 and 440 might store different partner IDs (either Deployment Partner IDs, Software Partner IDs, or both). For example, between the deployment of devices 425 and 440, customer 125 of FIG. 1 might have switched to a different partner, either for deployment of the hardware or installation of the software. Thus, aggregator might be aggregating data for any number of partners, either deployment partners or software partners.

In addition to receiving captured metrics 435 from device 425 internal to server 405, aggregator 135 can also receive captured metrics 445 from device 440. In contrast to device 425, device 440 is not internal to server 405, but rather is connected to server 405 (and aggregator 135) via network 415. Thus, FIG. 4 shows that a single aggregator 135 can aggregate metrics for all devices within customer 125 of FIG. 1, regardless of their location. All that is needed is that aggregator 135 can somehow receive the captured metrics from the device.

As described above, one reason to use RAID controller 430 is that RAID controller 430 can signal devices, such as device 205 of FIG. 2 or device 425, when to report their captured metrics. Since a RAID includes multiple disks, in theory each disk can report its captured metrics while the other disks handle any transaction requests from server 405. (Of course, if the RAID is operating in RAID 0, or striping without any mirroring, then transactions that involve the disk reporting its captured metrics have to wait for the device to receive transactions before they can be satisfied. But RAID 0 is almost never used by customers requiring any degree of redundancy in their data storage.)

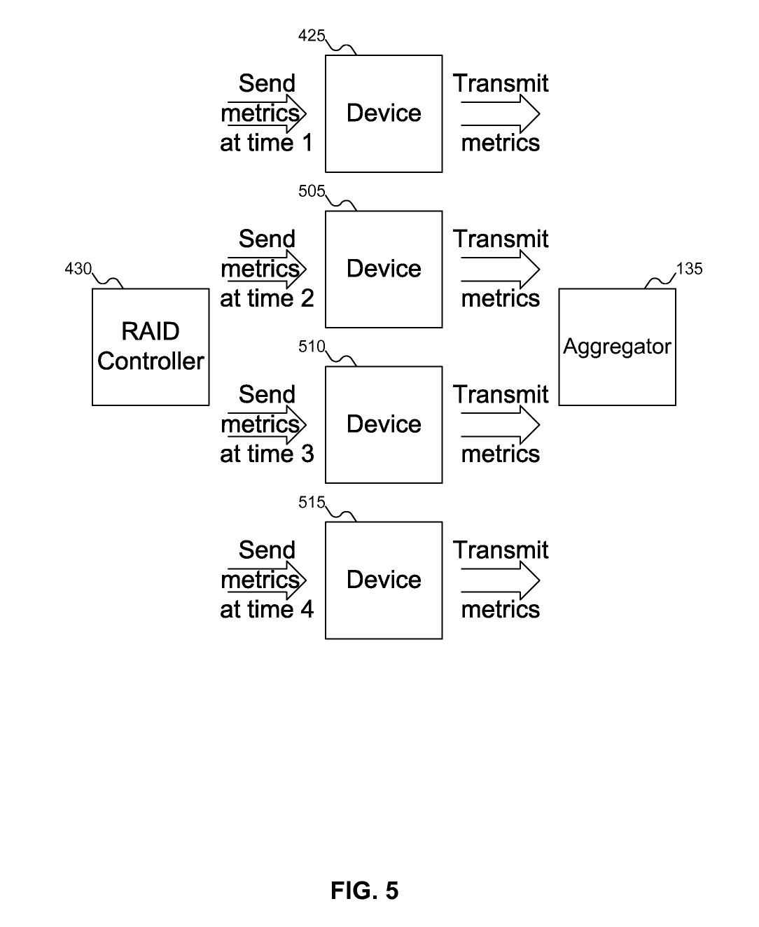

FIG. 5 shows an example of RAID controller 430 of FIG. 4 instructing devices such as devices 205 and 425 of FIGS. 2 and 4 on when to report metrics back to manufacturer 110 of FIG. 1 or aggregator 135 of FIGS. 1 and 4. In FIG. 5, RAID controller 430 is shown as controlling a RAID that includes four devices 425, 505, 510, and 515. RAID controller 430 sends signals to each device in turn, instructing the device to transmit its metrics to aggregator 135. For example, if the schedule involves devices 425, 505, 510, and 515 to report their captured metrics once every second, RAID controller 430 can signal each device to transmit their metrics at 250 millisecond (ms) intervals. In this manner, only one device transmits its metrics at any time, and therefore only one device is “removed” from the RAID at a time. From the perspective of server 405, the RAID should appear to be in continuous operation without any down-time, even though individual devices in the RAID are periodically reporting their metrics to aggregator 135 (and thus unable to process data transactions).

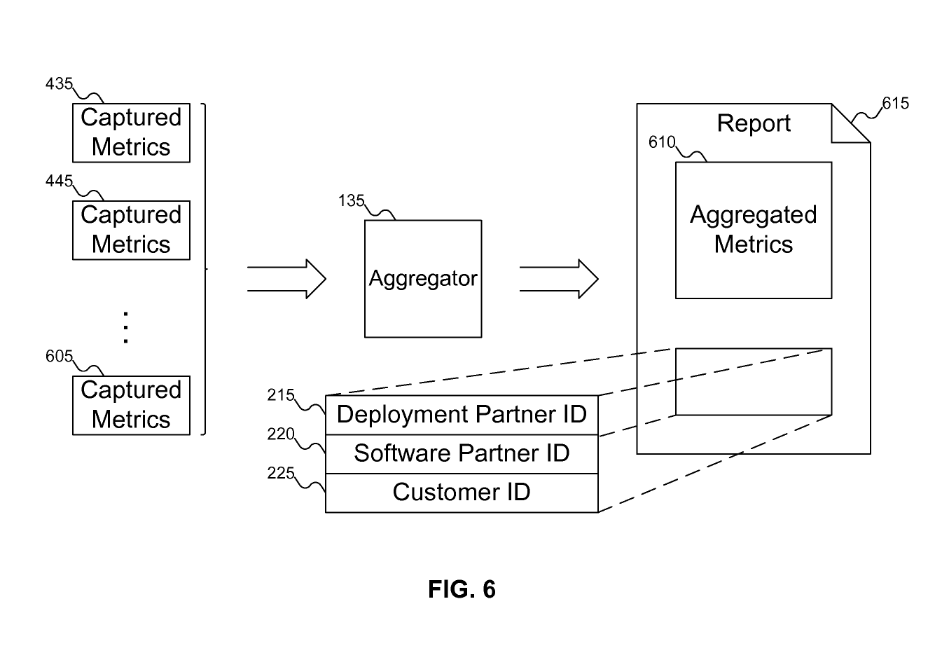

FIG. 6 shows an example of aggregator 135 of FIGS. 1 and 4 according to an embodiment of the inventive concept aggregating metrics from various devices before reporting the metrics to manufacturer 110 of FIG. 1. In FIG. 6, aggregator 135 is shown as receiving captured metrics 435, 445, and 605, among others. These captured metrics can be captured from the same device 205, 425, or 440 of FIGS. 2 and 4 at different times, from different devices 205, 425, or 440 of FIGS. 2 and 4, or any combination thereof. Aggregator 135 can combine these metrics into aggregated metrics 610, which can be included in report 615. Report 615 is also shown as including Deployment Partner ID 215 and Software Partner ID 220 to enable manufacturer 110 of FIG. 1 to determine whether a partner 105 of FIG. 1 has satisfied the objectives of an incentive offered by manufacturer 110 of FIG. 1. As discussed above, report 615 can also include Customer ID 225 to enable manufacturer 110 to determine whether any of devices 205, 425, or 440 of FIGS. 2 and 4 might have entered the grey market.

While FIG. 6 describes aggregator 135 in the context of being installed in server 405 of FIG. 4, in other embodiments of the inventive concept aggregator 135 can be managed by manufacturer 110 of FIG. 1, or can be managed by a third party. Regardless of its location, aggregator 135 performs the same function: to collect metrics 305 of FIG. 3 about how customers such as customer 125 of FIG. 1 are utilizing devices 205, 425, and 440 of FIGS. 2 and 4. Note also that when aggregator 135 operates within server 405 of FIG. 4 of customer 125 of FIG. 1, aggregator 135 is only aggregating data for a single customer. But when manufacturer 110 of FIG. 1 receives aggregated data 615 from aggregator 135 in report 615, aggregated data 135 represents aggregated data from only one customer 125 of FIG. 1. Thus, manufacturer 110 can re-aggregate captured metrics 435 and 445, combining them with captured metrics from other customers. This re-aggregation is essentially the same operation as that performed by aggregator 135.

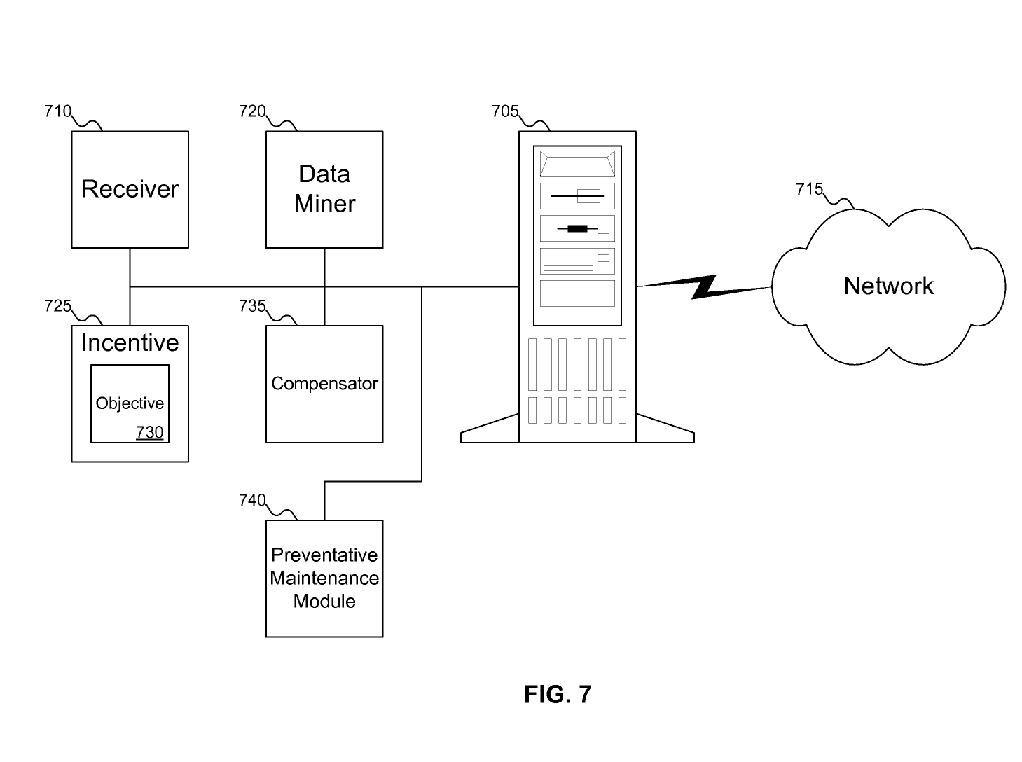

FIG. 7 shows an example of a server acting as the manufacturer of FIG. 1, according to an embodiment of the inventive concept. In FIG. 7, server 705 is shown. Server 705 can include receiver 710, which can receive data, such as metrics 305 about device 205. Receiver 710 can be a standard interconnect communicating with other portions of a standard computer system. In an embodiment of the inventive concept, server 705 can receive data over network 715. Typically, network 715 can be a network that connects manufacturer 110 of FIG. 1 with customer 125 of FIG. 1, such as the Internet. But a person skilled in the art will recognize that network 715 can be any other type of network, such as Local Area Network (LAN), Wide Area Network (WAN), or Virtual Private Network (VPN). In addition, although FIG. 7 shows only one network 715, a person skilled in the art will recognize that server 705 can be connected to any number of networks, each network being of the same or different type.

Server 705 can use data miner 720 to mine data from metrics 305 of FIG. 3 received via receiver 710. Mining data from metrics 305 of FIG. 3 involves analyzing metrics 305 to distill data of particular interest. Server 705 can use this mined data to determine whether partner 105 of FIG. 1 has achieved the objective of an incentive. For example, in FIG. 7, incentive 725 is shown, which has objective 730. Data miner 720 can analyze metrics 305 of FIG. 3 to determine whether partner 105 of FIG. 1 has met objective 730. To continue the example, objective 730 might specify that partner 105 of FIG. 1 needs to deploy 10,000 SSDs in a business quarter to qualify for incentive 725. Data miner 720 can calculate the number of SSDs deployed by partner 105 of FIG. 1 in the current business quarter, by counting the number of unique SSDs that have “phoned home” to manufacturer 110 in the current business quarter. (If devices “phone home” to aggregator 135 of FIG. 1 rather than directly to manufacturer 110 of FIG. 1, then data miner 720 can review metrics 305 of FIG. 3 to determine how many unique devices are represented.) If partner 105 has achieved objective 730, then partner 105 can be compensated according to incentive 725. Compensator 735 can be used to compensate partner 105.

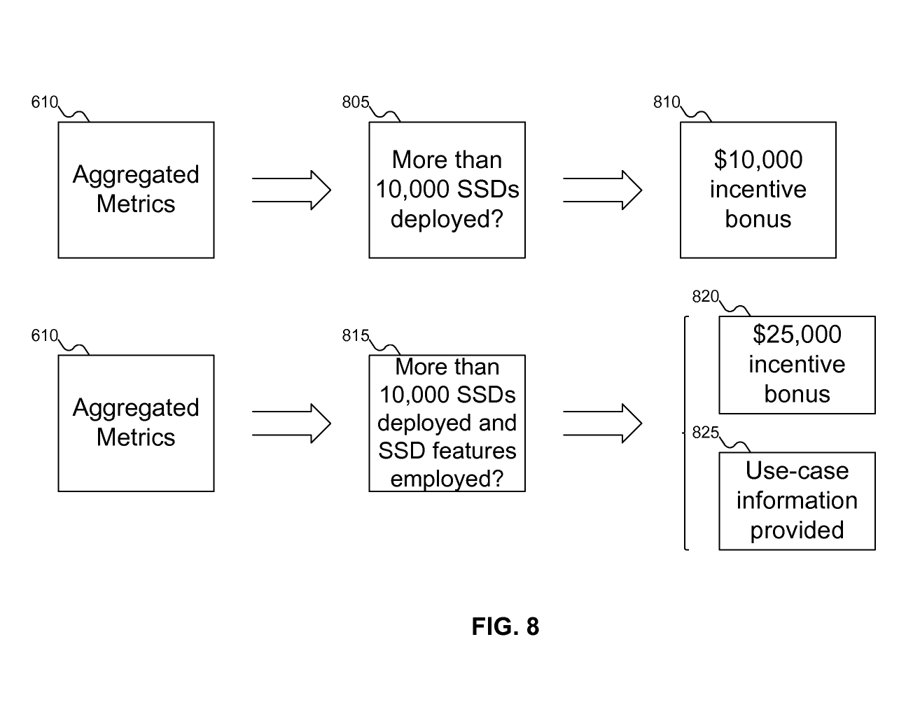

FIG. 8 shows examples of how manufacturer 110 of FIG. 1 can use the aggregated metrics of FIG. 6 to determine whether a partner qualifies for an incentive, according to embodiments of the inventive concept. In FIG. 8, two different incentive programs are offered. Objective 805 indicates that if a partner manages to deploy more than 10,000 SSDs in a fiscal quarter, then the partner will receive a $10,000 bonus (incentive 810). Manufacturer 110 of FIG. 1 can use aggregated metrics 610 (which can also factor in captured metrics from device 205 of FIG. 2 from other customers 125 of FIG. 1) to determine if partner 105 of FIG. 1 has deployed more than 10,000 SSDs in the fiscal quarter. If so, then manufacturer 110 of FIG. 1 can award partner 105 of FIG. 1 $10,000 (incentive 810).

In contrast, objective 815 indicates that if a partner manages to deploy more than 10,000 SSDs, each of which have features employed (metric 350), then the partner will receive a $25,000 bonus (incentive 820) and receive use-case information about the SSDs (incentive 825). Manufacturer 110 of FIG. 1 can use aggregated metrics 610 (again, which can factor in captured metrics from device 205 of FIG. 2 from other customers 125 of FIG. 1) to determine if partner 105 of FIG. 1 has deployed more than 10,000 SSDs with features employed in the fiscal quarter. If so, then manufacturer 110 of FIG. 1 can award partner 105 $25,000 (incentive 820) and provide partner 105 of FIG. 1 with use-case information (incentive 825).

Returning to FIG. 7, data miner 720 has other uses as well. Server 705 can use data miner 720 to determine if devices 205, 425, and/or 440 of FIGS. 2 and 4 of customer 125 of FIG. 1 require preventative maintenance, which can be provided using preventative maintenance module 740. For example, if wear endurance (metric 320 of FIG. 3) can indicate that devices 205, 425, and/or 440 of FIGS. 2 and 4 have soft error counts greater than expected, then devices 205, 425, and/or 440 of FIGS. 2 and 4 might be in need of preventative maintenance to address the problem. This preventative maintenance can include anything from updating the firmware in devices 205, 425, and/or 440 of FIGS. 2 and 4 or enhancing error correcting codes in devices 205, 425, and/or 440 of FIGS. 2 and 4 to replacing devices 205, 425, and/or 440 of FIGS. 2 and 4, as appropriate to the circumstances.

Another use for data miner 720 is to determine whether devices 205, 425, and/or 440 of FIGS. 2 and 4 are on the grey market. If devices 205, 425, and/or 440 of FIGS. 2 and 4 report a customer ID that is inconsistent with where manufacturer 110 of FIG. 1 expects devices 205, 425, and/or 440 of FIGS. 2 and 4 to be, then devices 205, 425, and/or 440 of FIGS. 2 and 4 might have been sold on the grey market. Alternatively, if manufacturer 110 of FIG. 1 believes that devices 205, 425, and/or 440 of FIGS. 2 and 4 are currently at a particular customer's location but devices 205, 425, and/or 440 of FIGS. 2 and 4 do not report any metrics 305 of FIG. 3 back to manufacturer 110 of FIG. 1, then devices 205, 425, and/or 440 of FIGS. 2 and 4 might have been sold on the grey market. Of course, a failure to report metrics 305 of FIG. 3 is not necessarily definitive proof that devices 205, 425, and/or 440 of FIGS. 2 and 4 were sold on the grey market: the devices might have failed and been replaced. But a failure to report metrics 305 of FIG. 3 can be indicative of a sale on the grey market.

If devices 205, 425, and 440 of FIGS. 2 and 4 are on the grey market rather than being installed at an appropriate customer location, manufacturer 110 of FIG. 1 can take appropriate action. For example, manufacturer 110 of FIG. 1 might be able to trace, using an identifier of device 205, 425, or 440 of FIGS. 2 and 4, which partner 105 of FIG. 1 had custody of the device. Manufacturer 110 of FIG. 1 could then penalize partner 105 of FIG. 1 for allowing device 205, 425, or 440 of FIGS. 2 and 4 to enter the grey market rather than be installed at a customer location.

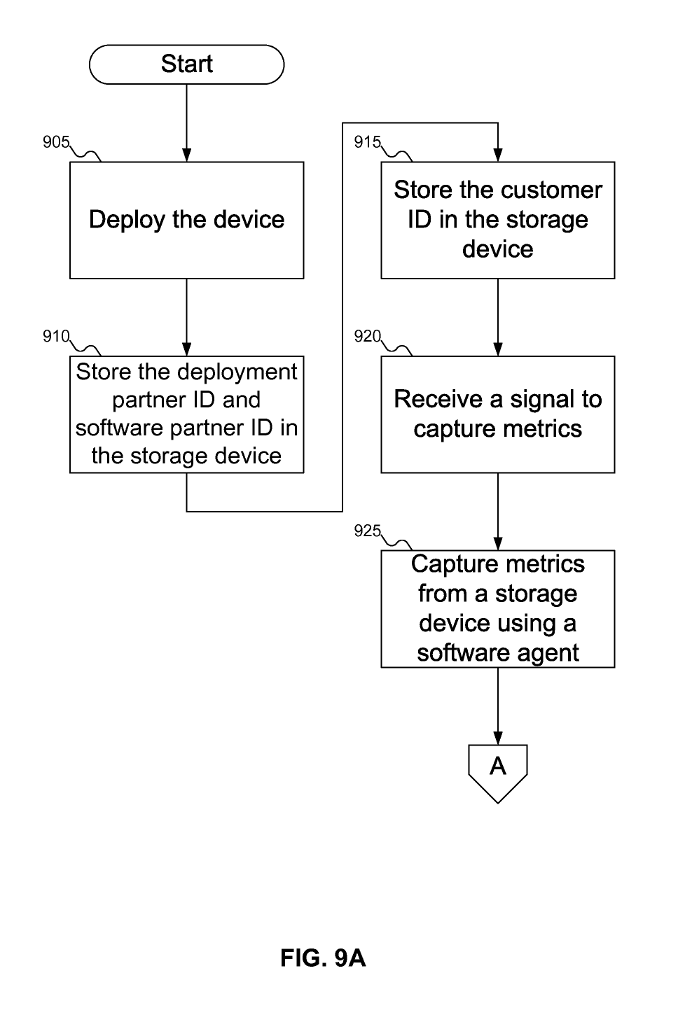

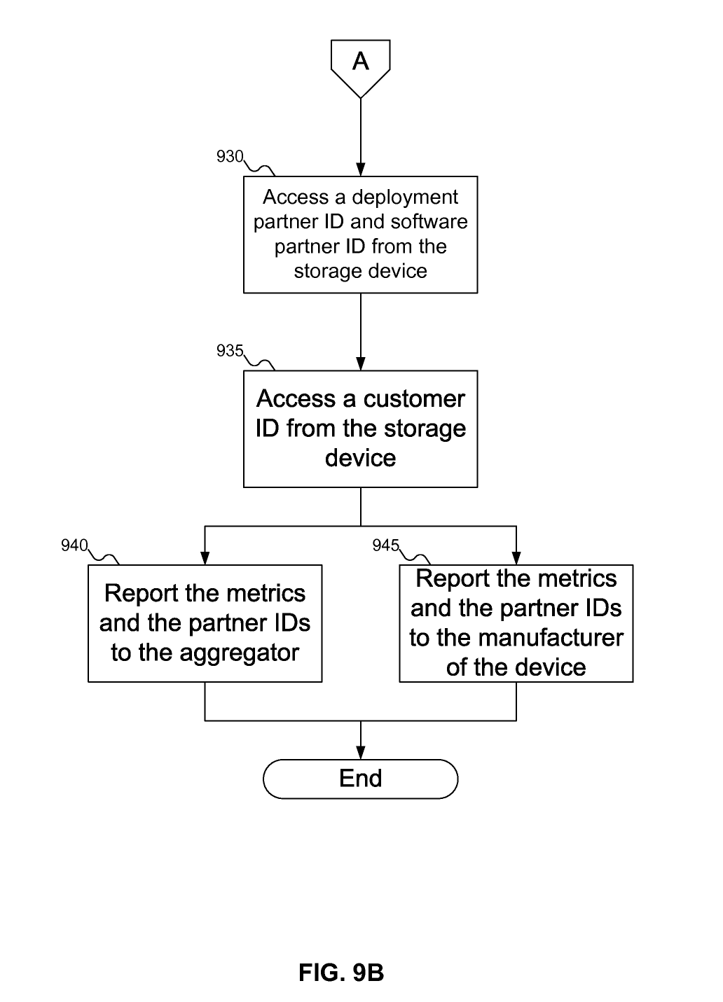

FIGS. 9A-9B show an example flowchart of a procedure for devices 205, 425, and 440 of FIGS. 2 and 4 to collect and report metrics to manufacturer 110 of FIG. 1, according to an embodiment of the inventive concept. In FIG. 9A, at block 905, deployment partner 105 of FIG. 1 can deploy devices 205, 425, and/or 440 of FIGS. 2 and 4 at customer 125 of FIG. 1. At block 910, deployment partner 105 of FIG. 1 or can store Deployment Partner ID 215 of FIG. 2 and Software Partner ID 220 of FIG. 2 in the storage of devices 205, 425, and/or 440 of FIGS. 2 and 4. At block 915, deployment partner 105 of FIG. 1 can store Customer ID 225 of FIG. 2 in the storage of devices 205, 425, and/or 440 of FIGS. 2 and 4. Alternatively, blocks 910 and 915 can be performed by manufacturer 110 of FIG. 1, rather than being stored by deployment partner 105 of FIG. 1. At block 920, storage devices 205, 425, and/or 440 can receive a signal from RAID controller 430 to capture metrics. As discussed above with reference to FIGS. 4-5, RAID controller 430 can signal storage devices 205, 1305, and/or 440 in turn, to present to server 405 the illusion that the RAID array is continuously available. At block 925, devices 205, 425, and/or 440 of FIGS. 2 and 4 can capture metrics, using (for example) metrics capture module 230 of FIG. 2.

At block 930 (FIG. 9B), metrics capture module 230 of FIG. 2 can access Deployment Partner ID 215 of FIG. 2 and Software Partner ID 220 of FIG. 2 from storage device 210 of FIG. 2. At block 935, metrics capture module 230 of FIG. 2 can access Customer ID 225 of FIG. 2 from storage device 210 of FIG. 2. Then, at block 940, devices 205, 425, and/or 440 of FIGS. 2 and 4 can report captured metrics 435 and/or 445 of FIG. 4 to aggregator 135 of FIGS. 1 and 4. Alternatively, at block 945, device 205, 425, and/or 440 of FIGS. 2 and 4 can report captured metrics 435 and/or 445 of FIG. 4 to manufacturer 110 of FIG. 1.

In FIGS. 9A-9B (and in the other flowcharts below), one embodiment of the inventive concept is shown. But a person skilled in the art will recognize that other embodiments of the inventive concept are also possible, by changing the order of the blocks, by omitting blocks, or by including links not shown in the drawings. All such variations of the flowcharts are considered to be embodiments of the inventive concept, whether expressly described or not.

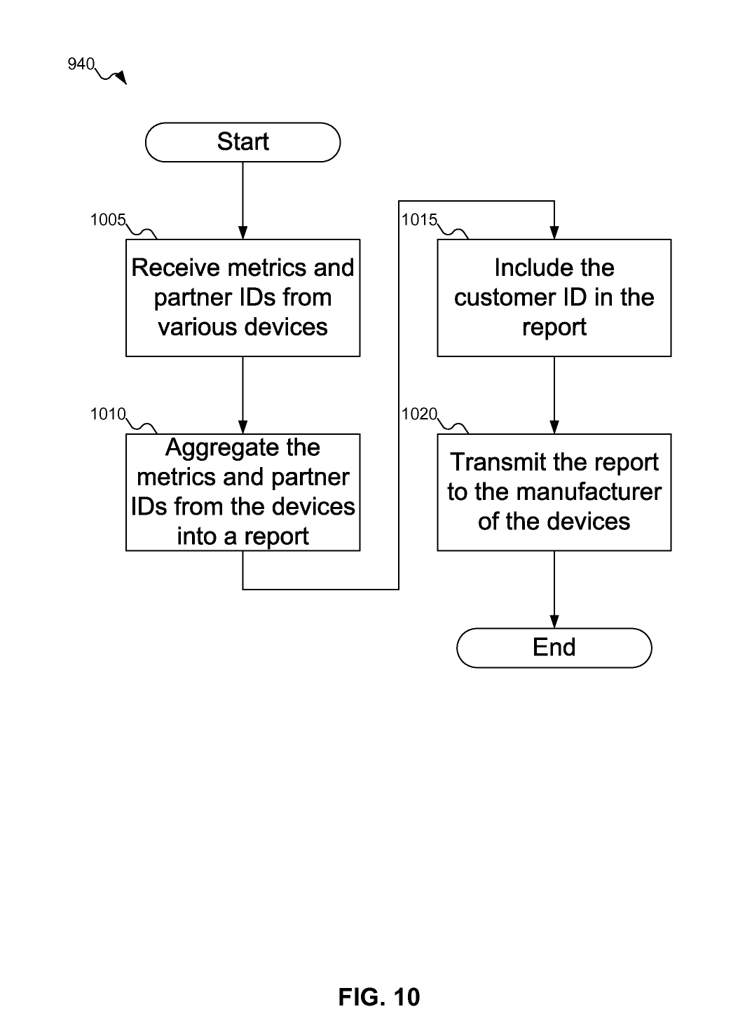

FIG. 10 shows an example flowchart of a procedure for aggregator 135 of FIGS. 1 and 4 to aggregate metrics from various devices 205, 425, and/or 440 of FIGS. 2 and 4 and report aggregated metrics 610 of FIG. 6 to manufacturer 110 of FIG. 1, according to an embodiment of the inventive concept. In FIG. 10, at block 1005, aggregator 135 of FIGS. 1 and 4 can receive captured metrics 435 and/or 445 of FIG. 4 from devices 205, 425, and/or 440 of FIGS. 2 and 4. At block 1010, aggregator 135 of FIGS. 1 and 4 can aggregate captured metrics 435 and/or 445 of FIG. 4 into aggregated metrics 610 of FIG. 6, and include aggregated metrics 610 of FIG. 6, Deployment Partner ID 215 of FIG. 2, and Software Partner ID 220 of FIG. 2 in report 615 of FIG. 6. At block 1015, aggregator 135 of FIGS. 1 and 4 can include Customer ID 225 of FIG. 2 in report 615 of FIG. 6. Finally, at block 1020, aggregator 135 of FIGS. 1 and 4 can transmit report 615 of FIG. 6 to manufacturer 110 of FIG. 1.

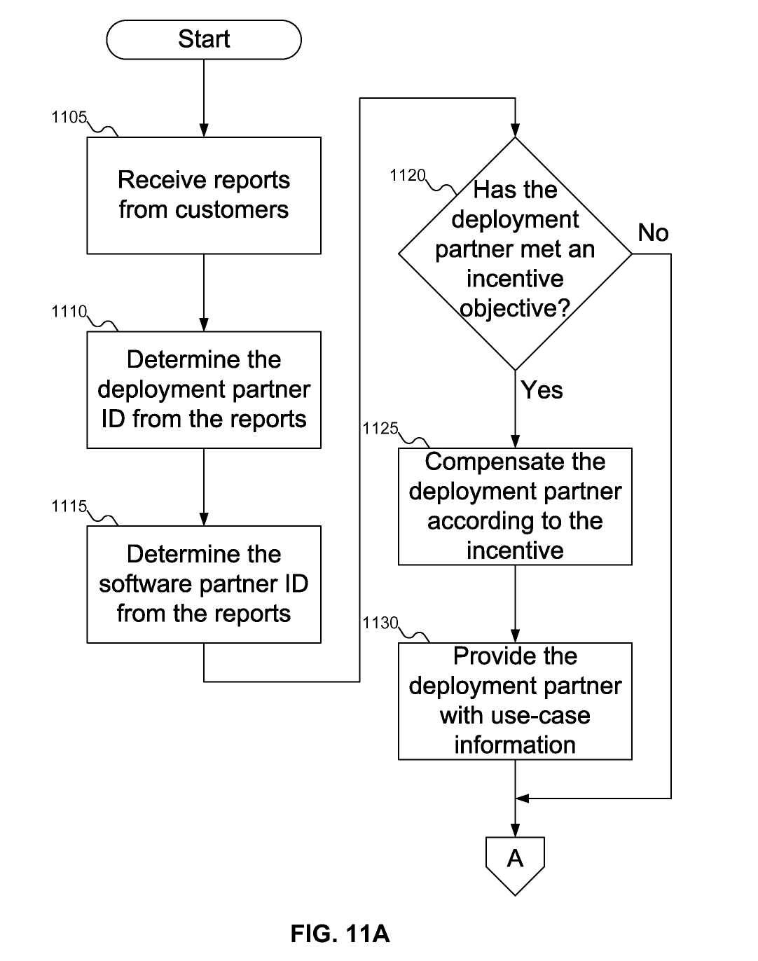

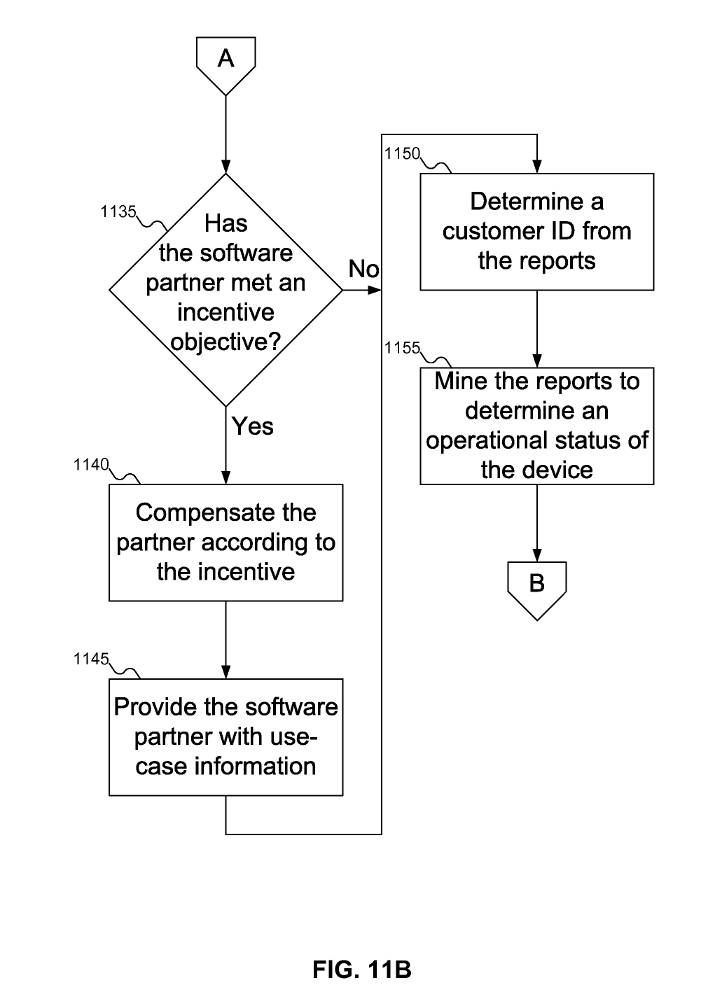

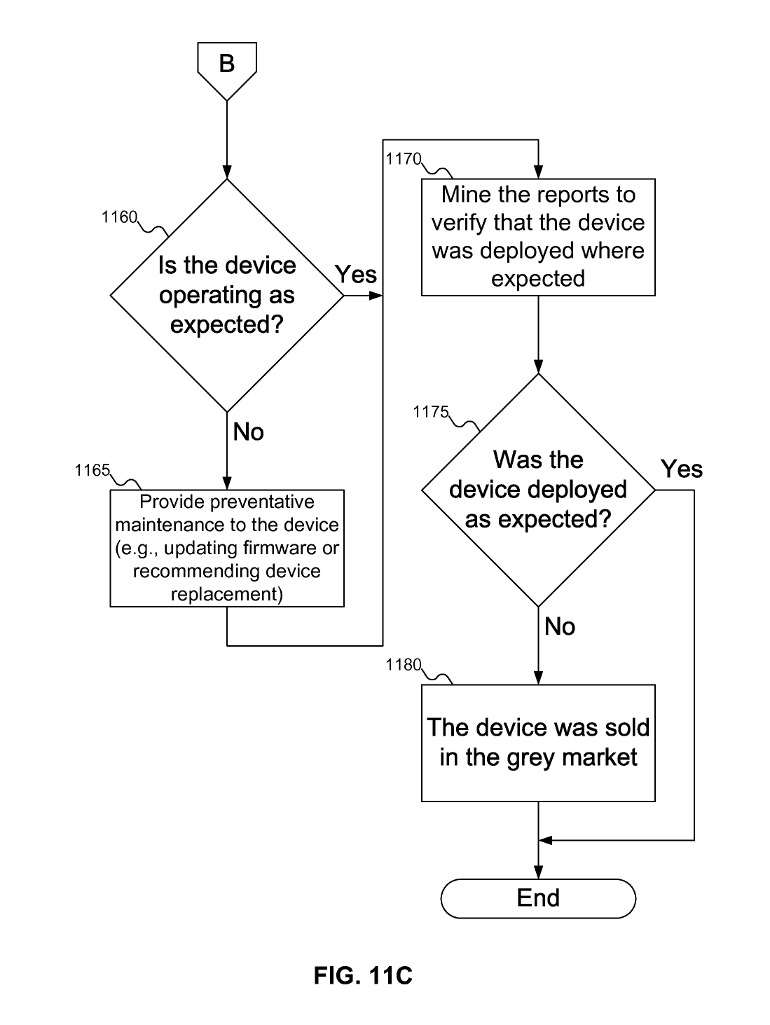

FIGS. 11A-11C show an example flowchart of a procedure for manufacturer 110 of FIG. 1 to mine the metrics from the devices of FIGS. 2 and 4 to determine whether a partner qualifies for an incentive, according to an embodiment of the inventive concept. In FIG. 11A, at block 1105, manufacturer 110 of FIG. 1 can receive reports 615 of FIG. 6 from customers. At block 1110, manufacturer 110 of FIG. 1 can determine Deployment Partner IDs 215 of FIG. 2 from reports 615 of FIG. 6. At block 1115, manufacturer 110 of FIG. 1 can determine Software Partner IDs 220 of FIG. 2 from reports 615 of FIG. 6. At decision point 1120, manufacturer 110 of FIG. 1 can mine aggregated metrics 610 of FIG. 6 from reports 615 of FIG. 6 to determine whether deployment partner 105 of FIG. 1 has met objectives 805 and/or 815 of FIG. 8 of incentives 810, 820, and 825 of FIG. 8. If so, then at block 1125, manufacturer 110 of FIG. 31 can compensate deployment partner 105 of FIG. 1 according to incentive 810, 820, and/or 825 of FIG. 8. This compensation can also include providing deployment partner 105 of FIG. 1 with use-case information, as shown in block 1130.

At decision point 1135 (FIG. 11B), manufacturer 110 of FIG. 1 can mine aggregated metrics 610 of FIG. 6 from reports 615 of FIG. 6 to determine whether software partner 105 of FIG. 1 has met objectives 805 and/or 815 of FIG. 8 of incentives 810, 820, and 825 of FIG. 8. If so, then at block 1140, manufacturer 110 of FIG. 1 can compensate software partner 105 of FIG. 1 according to incentive 810, 820, and/or 825 of FIG. 8. This compensation can also include providing software partner 105 of FIG. 1 with use-case information, as shown in block 1145. At block 1150, manufacturer 110 of FIG. 1 can determine Customer IDs 225 of FIG. 2 from reports 615 of FIG. 6. At block 1155, manufacturer 110 of FIG. 1 can mine aggregated metrics 610 of FIG. 6 to determine the operational status of devices 205, 425, and/or 440 of FIGS. 2 and 4.

At block 1160 (FIG. 11C), manufacturer 110 of FIG. 1 can determine if devices 205, 425, and/or 440 of FIGS. 2 and 4 are operating as expected. If not, then at block 1165, manufacturer 110 (or partner 105) of FIG. 1 can offer to perform preventative maintenance for customer 125 of FIG. 1. Examples of such preventative maintenance can include updating the firmware of device 205, 425, and/or 440 of FIGS. 2 and 4, or replacing device 205, 425, and/or 440 of FIGS. 2 and 4, among other possibilities.

Regardless of whether devices 205, 425, and/or 440 of FIGS. 2 and 4 require preventative maintenance, at block 1170, manufacturer 110 of FIG. 1 can mine aggregated metrics 610 of FIG. 6 to verify that devices 205, 425, and/or 440 of FIGS. 2 and 4 were deployed as expected. At block 1175, manufacturer 110 of FIG. 1 can determine if devices 205, 425, and/or 440 of FIGS. 2 and 4 were deployed as expected. If not, then at block 1180 manufacturer 110 of FIG. 1 can determine that devices 205, 425, and/or 440 of FIGS. 2 and 4 were sold on the grey market rather than being deployed as expected.

In block 1170, manufacturer 110 of FIG. 1 can also use aggregated metrics 610 of FIG. 6 to determine if a device that was expected to be deployed at customer 125 of FIG. 1 is not present. While a lack of metrics for devices 205, 425, and/or 440 of FIGS. 2 and 4 does not definitively establish that devices 205, 425, and/or 440 of FIGS. 2 and 4 have been sold on the grey market (device 205, 425, and/or 440 of FIGS. 2 and 4 might have been replaced due to failure), a lack of metrics for devices 205, 425, and/or 440 of FIGS. 2 and 4 when devices 205,425, and/or 440 of FIGS. 2 and 4 should be operational can suggest that devices 205, 425 and/or 440 of FIGS. 2 and 4 have been resold on the grey market.

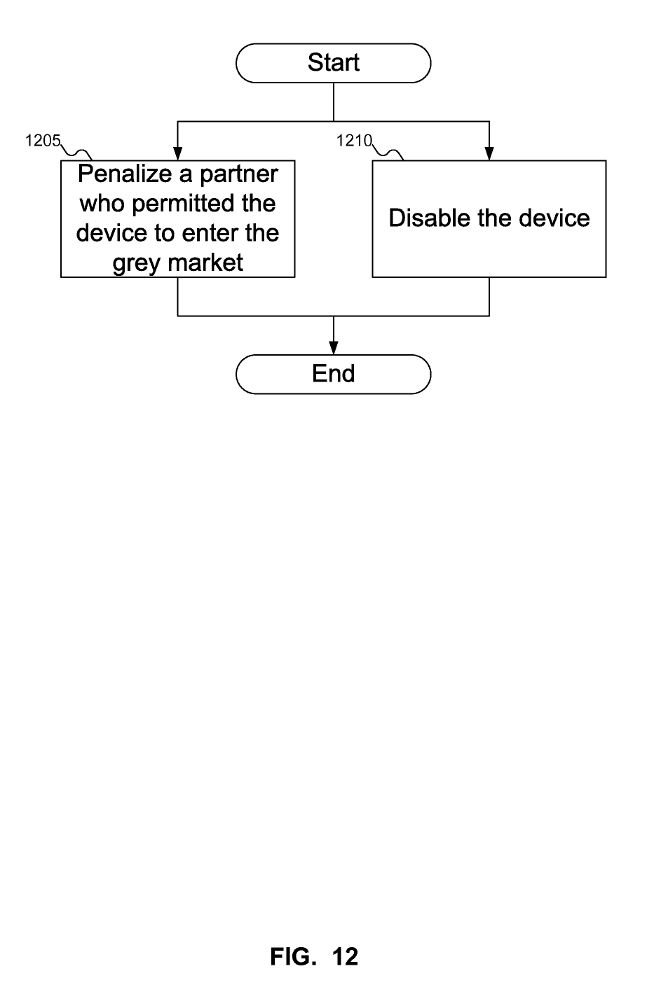

FIG. 12 shows an example flowchart of a procedure for manufacturer 110 of FIG. 1 to handle device 205, 425, or 440 of FIGS. 2 and 4 that has entered the grey market, according to an embodiment of the inventive concept. At block 1205, manufacturer 110 of FIG. 1 can penalize a partner that permitted device 205, 425, or 440 of FIGS. 2 and 4 to enter the grey market. Such a penalty can include, for example, a financial penalty to partner 105 of FIG. 1, or temporarily or permanently denying partner 105 of FIG. 1 access to products of manufacturer 110 of FIG. 1, among other possibilities. A financial penalty could be to ask partner 105 of FIG. 1 to pay a fine for permitting device 205, 425, or 440 of FIGS. 2 and 4 to enter the grey market, increasing the cost to partner 105 of FIG. 1 for future products of manufacturer 110 of FIG. 1, or denying payment of a satisfied incentive to partner 105 of FIG. 1.

Alternatively (or in addition to block 1205), at block 1210 manufacturer 110 of FIG. 1 can disable device 205, 425, or 440 of FIGS. 2 and 4. For example, manufacturer 110 of FIG. 1 can send a signal to device 205, 425, or 440 of FIGS. 2 and 4, instructing device 205, 425, or 440 of FIGS. 2 and 4 to stop operating. Disabling device 205, 425, or 440 of FIGS. 2 and 4 could be simply instructing device 205, 425, or 440 of FIGS. 2 and 4 to stop responding to requests from server 405 of FIG. 4 and other computers of the customer, or to destroy itself, rendering the data thereon (hopefully) permanently inaccessible, among other possibilities.

The following discussion is intended to provide a brief, general description of a suitable machine or machines in which certain aspects of the inventive concept can be implemented. Typically, the machine or machines include a system bus to which is attached processors, memory, e.g., random access memory (RAM), read-only memory (ROM), or other state preserving medium, storage devices, a video interface, and input/output interface ports. The machine or machines can be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines can include embedded controllers, such as programmable or non-programmable logic devices or arrays, Application Specific Integrated Circuits (ASICs), embedded computers, smart cards, and the like. The machine or machines can utilize one or more connections to one or more remote machines, such as through a network interface, modem, or other communicative coupling. Machines can be interconnected by way of a physical and/or logical network, such as an intranet, the Internet, local area networks, wide area networks, etc. One skilled in the art will appreciate that network communication can utilize various wired and/or wireless short range or long range carriers and protocols, including radio frequency (RF), satellite, microwave, Institute of Electrical and Electronics Engineers (IEEE) 802.11, Bluetooth®, optical, infrared, cable, laser, etc.

Embodiments of the present inventive concept can be described by reference to or in conjunction with associated data including functions, procedures, data structures, application programs, etc. which when accessed by a machine results in the machine performing tasks or defining abstract data types or low-level hardware contexts. Associated data can be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Embodiments of the inventive concept can include a tangible, non-transitory machine-readable medium comprising instructions executable by one or more processors, the instructions comprising instructions to perform the elements of the inventive concepts as described herein.

Having described and illustrated the principles of the inventive concept with reference to illustrated embodiments, it will be recognized that the illustrated embodiments can be modified in arrangement and detail without departing from such principles, and can be combined in any desired manner. And, although the foregoing discussion has focused on particular embodiments, other configurations are contemplated. In particular, even though expressions such as “according to an embodiment of the inventive concept” or the like are used herein, these phrases are meant to generally reference embodiment possibilities, and are not intended to limit the inventive concept to particular embodiment configurations. As used herein, these terms can reference the same or different embodiments that are combinable into other embodiments.

The foregoing illustrative embodiments are not to be construed as limiting the inventive concept thereof. Although a few embodiments have been described, those skilled in the art will readily appreciate that many modifications are possible to those embodiments without materially departing from the novel teachings and advantages of the present disclosure. Accordingly, all such modifications are intended to be included within the scope of this inventive concept as defined in the claims.

Embodiments of the inventive concept can extend to the following statements, without limitation:

Statement 1. An embodiment of the inventive concept includes a device, comprising:

a storage device, the storage device including storage for a partner ID, the partner ID identifying a partner of a manufacturer of the storage device;

a metrics capture module resident in the storage device, the metrics capture module capable of capturing metrics of operation of the storage device; and

a transmitter to transmit the captured metrics and the partner ID to the manufacturer,

wherein the manufacturer can use the captured metrics and the partner ID to provide an incentive to the partner.

Statement 2. An embodiment of the inventive concept includes a device according to statement 1, wherein:

the storage device is coupled to a RAID controller; and

the device further comprises a receiver to receive a signal from the RAID controller triggering a transmission of the captured metrics to the manufacturer.

Statement 3. An embodiment of the inventive concept includes a device according to statement 1, wherein the transmitter is operative to transmit the captured metrics to an aggregator, the aggregator capable of aggregating the captured metrics with second metrics from a second storage device and transmitting the aggregated metrics to the manufacturer.

Statement 4. An embodiment of the inventive concept includes a device according to statement 1, wherein the captured metrics a drawn from a set including capacity/time served, up-time, wear endurance, warranty, extended warranty, performance, workload profiles, applications served, features employed, and in-storage computing performance.

Statement 5. An embodiment of the inventive concept includes a device according to statement 1, wherein the partner ID includes a Deployment Partner ID and a Software Partner ID, and

the manufacturer can use the metrics and the Deployment Partner ID to provide an incentive to a deployment partner and the metrics and the Software Partner ID to provide an incentive to a software partner.

Statement 6. An embodiment of the inventive concept includes a device according to statement 1, wherein:

the storage device includes storage for a Customer ID, the Customer ID identifying a customer using the storage device; and

the transmitter is operative to transmit the captured metrics, the partner ID, and the Customer ID to the manufacturer,

wherein the manufacturer can use the Customer ID to verify that the storage device is not sold in a grey market.

Statement 7. An embodiment of the inventive concept includes an article, comprising a tangible storage medium, said tangible storage medium having stored thereon non-transitory instructions that, when executed by a machine, result in:

receiving first metrics and a partner ID from a first storage device at an aggregator, the partner ID identifying a partner of a manufacturer of the first storage device and a second storage device;

receiving second metrics and the partner ID from the second storage device at the aggregator;

aggregating the first metrics and the second metrics into a report, the report also including the partner ID; and

sending the report to the manufacturer,

wherein the manufacturer can use the aggregated metrics and the partner ID in the report to provide an incentive to the partner.

Statement 8. An embodiment of the inventive concept includes an article according to statement 7, wherein:

receiving first metrics from a first storage device at an aggregator includes receiving multiple first metrics from the first storage device at the aggregator;

receiving second metrics from a second storage device a an aggregator includes receiving multiple second metrics from the second storage device at the aggregator;

aggregating the first metrics and the second metrics into a report includes aggregating the multiple first metrics and the multiple second metrics into the report.

Statement 9. An embodiment of the inventive concept includes an article according to statement 7, wherein:

receiving first metrics from a first storage device at an aggregator includes receiving the first metrics from the first storage device at the aggregator at a first time;

receiving second metrics from a second storage device at the aggregator includes receiving the second metrics from the second storage device at the aggregator at a second time,

wherein the first time and the second time are staggered.

Statement 10. An embodiment of the inventive concept includes an article according to statement 7, wherein aggregating the first metrics and the second metrics into a report includes aggregating the first metrics and the second metrics into the report, the report also including the partner ID and a Customer ID; and

sending the report to the manufacturer,

wherein the manufacturer can use the Customer ID to verify that the first storage device and the second storage device are not sold in a grey market.

Statement 11. An embodiment of the inventive concept includes a system, comprising: a device, including:
a storage device, the storage device including storage for a partner ID, the partner ID identifying a partner of a manufacturer of the storage device;
a metrics capture module resident in the storage device, the metrics capture module capable of capturing metrics of operation of the storage device; and
a transmitter to transmit the captured metrics and the partner ID to an aggregator agent; and

a server, including
the aggregator agent, the aggregator agent capable of receiving captured metrics and the partner ID from the storage device and at least one other storage device and aggregating the captured metrics into a report, the report also including the partner ID; and
a transmitter to transmit the report to the manufacturer,

wherein the manufacturer can use the captured metrics and the partner ID to provide an incentive to the partner.

Statement 12. An embodiment of the inventive concept includes a system according to statement 11, wherein the device is installed within the server.

Statement 13. An embodiment of the inventive concept includes a system according to statement 12, wherein:

the server includes a RAID controller, the device coupled to the RAID controller; and

the device further comprises a receiver to receive a signal from the RAID controller triggering a transmission of the captured metrics to the aggregator agent.

Statement 14. An embodiment of the inventive concept includes a system according to statement 11, wherein the device communicates with the server across a network.

Statement 15. An embodiment of the inventive concept includes a system according to statement 11, wherein the partner ID includes a Deployment Partner ID and a Software Partner ID, and

the manufacturer can use the metrics and the Deployment Partner ID in the report to provide an incentive to a deployment partner and the metrics and the Software Partner ID in the report to provide an incentive to a software partner.

Statement 16. An embodiment of the inventive concept includes a system according to statement 11, wherein:

the storage device includes storage for a Customer ID, the Customer ID identifying a customer using the storage device; and

the transmitter is operative to transmit the captured metrics, the partner ID, and the Customer ID to the manufacturer,

wherein the manufacturer can use the Customer ID to verify that the storage device is not sold in a grey market.

Statement 17. An embodiment of the inventive concept includes a system, comprising:

a server;

a receiver on the server, the receiver operative to receive metrics from a device at a customer;

an incentive stored on the server;

an objective of the incentive stored on the server;

a data miner to mine the metrics to determine if a partner has achieved the objective of the incentive; and

a compensator to compensate the partner according to the incentive if the partner has achieved the objective of the incentive.

Statement 18. An embodiment of the inventive concept includes a system according to statement 17, wherein:

an incentive stored on the server includes a first plurality of incentives stored on the server; and

an objective of the incentive stored on the server includes a second plurality of objectives of the first plurality of incentive stored on the server.

Statement 19. An embodiment of the inventive concept includes a system according to statement 17, wherein the receiver is operative to receive the metrics from the device at the customer via an aggregator.

Statement 20. An embodiment of the inventive concept includes a system according to statement 19, wherein the receiver is further operative to receive the metrics and other metrics about at least a second device at the customer via the aggregator.

Statement 21. An embodiment of the inventive concept includes a system according to statement 17, wherein the receiver is operative to receive other metrics about at least a second device at a second customer.

Statement 22. An embodiment of the inventive concept includes a system according to statement 17, wherein the compensator is operative to provide the partner with use-case information regarding the devices.

Statement 23. An embodiment of the inventive concept includes a system according to statement 17, wherein the data miner is operative to mine the metrics to determine if the device was sold on a grey market.

Statement 24. An embodiment of the inventive concept includes a system according to statement 17, further comprising a preventative maintenance module to provide preventative maintenance to the device if the metrics indicate that the device requires preventative maintenance.

Statement 25. An embodiment of the inventive concept includes a method, comprising:

capturing metrics using a storage device, the storage device deployed for a customer by a partner of a manufacturer of the storage device;
accessing a partner ID stored in the storage device, the partner ID identifying the partner; and

reporting the metrics and the partner ID to the manufacturer of the storage device,

wherein the manufacturer can use the metrics and the partner ID to provide an incentive to the partner.

Statement 26. An embodiment of the inventive concept includes a method according to statement 25, wherein:

accessing a partner ID includes accessing a Deployment Partner ID and a Software Partner ID stored in the storage device, the Deployment Partner ID identifying a deployment partner and the Software Partner ID identifying a software partner; and

reporting the metrics and the partner ID to a manufacturer includes reporting the metrics, the Deployment Partner ID, and the Software Partner ID to the manufacturer;

wherein the manufacturer can use the metrics and the Deployment Partner ID to provide an incentive to the deployment partner and the metrics and the Software Partner ID to provide an incentive to the software partner.

Statement 27. An embodiment of the inventive concept includes a method according to statement 25, wherein capturing metrics includes receiving a signal from a RAID controller (430) at the storage device to capture the metrics.

Statement 28. An embodiment of the inventive concept includes a method according to statement 25, further comprising storing the partner ID in the storage device by the partner during deployment of the storage device.

Statement 29. An embodiment of the inventive concept includes a method according to statement 25, wherein capturing metrics using a storage device includes capturing the metrics using the storage device, the metrics drawn from a set including capacity/time served, up-time, wear endurance, warranty, extended warranty, performance, workload profiles, applications served, features employed, and in-storage computing performance.

Statement 30. An embodiment of the inventive concept includes a method according to statement 25, wherein reporting the metrics and the partner ID to a manufacturer includes:

reporting the metrics to an aggregator,

wherein the aggregator can aggregate the metrics with second metrics from a second storage device before reporting the aggregated metrics to the manufacturer.

Statement 31. An embodiment of the inventive concept includes a method according to statement 25, wherein:

accessing a partner ID stored in the storage device includes accessing a Customer ID stored in the storage device, the Customer ID identifying the customer; and

reporting the metrics and the partner ID to the manufacturer of the storage device includes reporting the metrics, the partner ID, and the Customer ID to the manufacturer of the storage device,

wherein the manufacturer can use the Customer ID to verify that the storage device is not sold in a grey market.

Statement 32. An embodiment of the inventive concept includes a method according to statement 25, further comprising:

receiving the metrics at a manufacturer;

mining the metrics to determine if the partner has achieved an objective of an incentive; and

if the partner has achieved the objective of the incentive, compensating the partner according to the incentive.

Statement 33. An embodiment of the inventive concept includes a method according to statement 32, wherein:

receiving the metrics includes receiving the metrics and a Customer ID, the Customer ID identifying the customer for whom the storage device was deployed; and

mining the metrics includes mining the metrics to determine if the storage device has entered a grey market.

Statement 34. An embodiment of the inventive concept includes a method according to statement 33, wherein mining the metrics to determine if the storage device has entered a grey market includes penalizing the partner for permitting the storage device to enter the grey market.

Statement 35. An embodiment of the inventive concept includes a method according to statement 33, wherein mining the metrics to determine if the storage device has entered a grey market includes disabling the storage device.

Statement 36. An embodiment of the inventive concept includes a method, comprising:

receiving first metrics and a partner ID from a first storage device at an aggregator, the partner ID identifying a partner of a manufacturer of the first storage device and a second storage device;

receiving second metrics and the partner ID from the second storage device at the aggregator;

aggregating the first metrics and the second metrics into a report, the report also including the partner ID; and

sending the report to the manufacturer,

wherein the manufacturer can use the aggregated metrics and the partner ID in the report to provide an incentive to the partner.

Statement 37. An embodiment of the inventive concept includes a method according to statement 36, wherein:

receiving first metrics from a first storage device at an aggregator includes receiving multiple first metrics from the first storage device at the aggregator;

receiving second metrics from a second storage device at the aggregator includes receiving multiple second metrics from the second storage device at the aggregator;

aggregating the first metrics and the second metrics into a report includes aggregating the multiple first metrics and the multiple second metrics into the report.

Statement 38. An embodiment of the inventive concept includes a method according to statement 36, wherein:

receiving first metrics from a first storage device at an aggregator includes receiving the first metrics from the first storage device at the aggregator at a first time;

receiving second metrics from a second storage device at the aggregator includes receiving the second metrics from the second storage device at the aggregator at a second time,

wherein the first time and the second time are staggered.

Statement 39. An embodiment of the inventive concept includes a method according to statement 38, wherein:

receiving the first metrics from the first storage device at the aggregator at a first time includes receiving the first metrics from the first storage device at the aggregator at the first time, the first storage device connected to a RAID controller; and

receiving the second metrics from the second storage device at the aggregator at a second time includes receiving the second metrics from the second storage device at the aggregator at the second time, the second storage device connected to the RAID controller,

wherein the RAID controller is operative to instruct the first storage device to report the first metrics to the aggregator at the first time and to instruct the second storage device to report the second metrics to the aggregator at the second time.

Statement 40. An embodiment of the inventive concept includes a method according to statement 36, wherein aggregating the first metrics and the second metrics into a report includes aggregating the first metrics and the second metrics into the report, the report also including the partner ID and a Customer ID, the Customer ID identifying a customer for whom the storage device was deployed; and

sending the report to the manufacturer,

wherein the manufacturer can use the Customer ID to verify that the first storage device and the second storage device are not sold in a grey market.

Statement 41. An embodiment of the inventive concept includes a method, comprising:

receiving reports from a plurality of customers, each report including captured metrics for at least one storage device and a partner ID, the partner ID identifying a partner of a manufacturer of the storage device;

mining the reports to determine if the partner has achieved an objective of an incentive; and

if the partner has achieved the objective of the incentive, compensating the partner according to the incentive.

Statement 42. An embodiment of the inventive concept includes a method according to statement 41, wherein:

mining the reports includes mining the reports to determine if the partner has achieved an objective of each of a plurality of incentives; and

compensating the partner according to the incentive includes, if the partner has achieved the objective of any of the plurality of incentives, compensating the partner according to incentives for which the partner has achieved the objective.

Statement 43. An embodiment of the inventive concept includes a method according to statement 41, wherein:

receiving reports includes receiving the reports from the plurality of customers, each report including captured metrics for the at least one storage device, a Deployment Partner ID, and a Software Partner ID, the Deployment Partner ID identifying a deployment partner of the manufacturer of the storage device and the Software Partner ID identifying a software partner of the manufacturer of the storage device;

mining the reports includes:
mining the reports to determine if the deployment partner has achieved an objective of a first incentive; and
mining the reports to determine if the software partner has achieved an objective of a second incentive; and

compensating the partner according to the incentive includes:
if the deployment partner has achieved the objective of the first incentive, compensating the deployment partner according to the first incentive; and
if the software partner has achieved the objective of the second incentive, compensating the software partner according to the second incentive.

Statement 44. An embodiment of the inventive concept includes a method according to statement 41, wherein compensating the partner according to the incentive includes providing the partner with use-case information regarding the storage devices.

Statement 45. An embodiment of the inventive concept includes a method according to statement 41, wherein:

receiving reports includes receiving the reports from a plurality of customers, each report including captured metrics for at least one storage device, a partner ID, and a Customer ID, the Customer ID identifying a customer for whom the at least one storage device was deployed; and

mining the reports includes mining the reports to determine if any storage device has entered a grey market.

Statement 46. An embodiment of the inventive concept includes a method according to statement 45, wherein mining the reports to determine if any storage device has entered a grey market includes penalizing the partner for permitting the storage device to enter the grey market.

Statement 47. An embodiment of the inventive concept includes a method according to statement 45, wherein mining the reports to determine if any storage device has entered a grey market includes disabling the storage device.

Statement 48. An embodiment of the inventive concept includes a method according to statement 41, further comprising:

mining the reports includes mining the reports to determine an operative status of the at least one storage device; and

if the operating status of the at least one storage device indicates the at least one storage device requires maintenance, providing preventative maintenance to the at least one storage device.

Statement 49. An embodiment of the inventive concept includes a method according to statement 43, wherein providing preventative maintenance to the at least one storage device includes updating a firmware of the at least one storage device.

Statement 50. An embodiment of the inventive concept includes a method according to statement 44, wherein providing preventative maintenance to the at least one storage device includes recommending replacement of the at least one storage device.

Statement 51. An embodiment of the inventive concept includes a method, comprising:

receiving reports from a plurality of customers, each report including captured metrics for at least one storage device and a partner ID, the partner ID identifying a partner of a manufacturer of the storage device;

mining the reports to determine if any storage device has entered a grey market; and

penalizing the partner for permitting the storage device to enter the grey market.

Statement 52. An embodiment of the inventive concept includes a method according to statement 51, further comprising disabling the storage device.

Statement 53. An embodiment of the inventive concept includes a method, comprising:

capturing metrics using a storage device, the storage device deployed for a customer by a partner of a manufacturer of the storage device;

accessing a partner ID stored in the storage device, the partner ID identifying the partner;

reporting the metrics and the partner ID to the manufacturer of the storage device;

receiving the metrics and the partner ID at the manufacture of the storage device receiving other metrics and the partner ID at the manufacturer;

mining the metrics and the other metrics by the manufacturer to determine if the partner has achieved an objective of an incentive; and

if the partner has achieved the objective of the incentive, compensating the partner according to the incentive.

Statement 54. An embodiment of the inventive concept includes a method according to statement 53, wherein:

accessing a partner ID includes accessing a Deployment Partner ID and a Software Partner ID stored in the storage device, the Deployment Partner ID identifying a deployment partner and the Software Partner ID identifying a software partner;

reporting the metrics and the partner ID to a manufacturer includes reporting the metrics, the Deployment Partner ID, and the Software Partner ID to the manufacturer;

mining the reports includes:
mining the reports to determine if the deployment partner has achieved an objective of a first incentive; and
mining the reports to determine if the software partner has achieved an objective of a second incentive; and

compensating the partner according to the incentive includes:
if the deployment partner has achieved the objective of the first incentive, compensating the deployment partner according to the first incentive; and
if the software partner has achieved the objective of the second incentive, compensating the software partner according to the second incentive.

Statement 55. An embodiment of the inventive concept includes a method according to statement 53, wherein receiving other metrics and the partner ID at the manufacturer includes receiving the other metrics and the partner ID at the manufacturer from at least a second customer.

Statement 56. An embodiment of the inventive concept includes a method according to statement 53, wherein capturing metrics using a storage device includes capturing the metrics using the storage device, the metrics drawn from a set including capacity/time served, up-time, wear endurance, warranty, extended warranty, performance, workload profiles, applications served, features employed, and in-storage computing performance.

Statement 57. An embodiment of the inventive concept includes a method according to statement 53, wherein:

accessing a partner ID stored in the storage device includes accessing a Customer ID stored in the storage device, the Customer ID identifying the customer;

reporting the metrics and the partner ID to the manufacturer of the storage device includes reporting the metrics, the partner ID, and the Customer ID to the manufacturer of the storage device; and

the method further comprises using the Customer ID by the manufacturer to determine whether the storage device was sold in a grey market.

Statement 58. An embodiment of the inventive concept includes a method according to statement 57, wherein using the Customer ID by the manufacturer includes penalizing the partner for permitting the storage device to enter the grey market.

Statement 59. An embodiment of the inventive concept includes a method according to statement 57, wherein using the Customer ID by the manufacturer includes disabling the storage device.

Statement 60. An embodiment of the inventive concept includes a method according to statement 53, wherein reporting the metrics and the partner ID to the manufacturer of the storage device includes:

reporting the metrics and the partner ID from the storage device to an aggregator;

receiving the metrics and the partner ID from the storage device at the aggregator;

receiving second metrics and the partner ID from a second storage device at the aggregator;

aggregating the first metrics and the second metrics into a report, the report also including the partner ID; and

sending the report to the manufacturer.

Statement 61. An embodiment of the inventive concept includes a method according to statement 60, wherein:

receiving the metrics from a first storage device at an aggregator includes receiving multiple metrics from the first storage device at the aggregator;

receiving second metrics from a second storage device at the aggregator includes receiving multiple second metrics from the second storage device at the aggregator;

aggregating the first metrics and the second metrics into a report includes aggregating the multiple metrics and the multiple second metrics into the report.

Statement 62. An embodiment of the inventive concept includes a method according to statement 60, wherein:

aggregating the metrics and the second metrics into a report includes aggregating the metrics and the second metrics into the report, the report also including the partner ID and a Customer ID, the Customer ID identifying a customer for whom the storage device was deployed; and

the method further comprises using the Customer ID by the manufacturer to determine whether the storage device was sold in a grey market.

Statement 63. An embodiment of the inventive concept includes a method according to statement 62, wherein using the Customer ID by the manufacturer includes penalizing the partner for permitting the storage device to enter the grey market.

Statement 64. An embodiment of the inventive concept includes a method according to statement 62, wherein using the Customer ID by the manufacturer includes disabling the storage device.

Statement 65. An embodiment of the inventive concept includes a method according to statement 53, wherein:

mining the metrics includes mining the metrics and the other metrics to determine if the partner has achieved an objective of each of a plurality of incentives; and

compensating the partner according to the incentive includes, if the partner has achieved the objective of any of the plurality of incentives, compensating the partner according to incentives for which the partner has achieved the objective.

Statement 66. An embodiment of the inventive concept includes a method according to statement 53, wherein compensating the partner according to the incentive includes providing the partner with use-case information regarding the storage devices.

Consequently, in view of the wide variety of permutations to the embodiments described herein, this detailed description and accompanying material is intended to be illustrative only, and should not be taken as limiting the scope of the inventive concept. What is claimed as the inventive concept, therefore, is all such modifications as may come within the scope and spirit of the following claims and equivalents thereto.

What is claimed is:

1. A device (205, 425, 440), comprising:
a storage device (210), the storage device (210) including storage for a partner ID (215, 220), the partner ID (215, 220) identifying a partner (105) of a manufacturer (110) of the storage device (210);
a metrics capture module (230) capable of capturing (140, 925) metrics (305, 435, 445, 605) of operation of the storage device (210); and
a transmitter (235) to transmit the captured metrics (305, 435, 445, 605) and the partner ID (215, 220) to the manufacturer (110),
wherein the manufacturer (110) can use the captured metrics (305, 435, 445, 605) and the partner ID (215, 220) to provide an incentive (725, 810, 820, 825) to the partner (105).

2. A device (205, 425, 440) according to claim 1, wherein:
the storage device (210) is coupled to a RAID controller (430); and
the device (205, 425, 440) further comprises a receiver (240) to receive a signal from the RAID controller (430) triggering a transmission of the captured metrics (305, 435, 445, 605) to the manufacturer (110).

3. A device (205, 425, 440) according to claim 1, wherein the transmitter (235) is operative to transmit the captured metrics (305, 435, 445, 605) to an aggregator (135), the aggregator (135) capable of aggregating (145, 1010) the captured metrics (305, 435, 445, 605) with second metrics (305, 435, 445, 605) from a second storage device (210) and transmitting the aggregated metrics (610) to the manufacturer (110).

4. A device (205, 425, 440) according to claim 1, wherein the captured metrics (305, 435, 445, 605) a drawn from a set including capacity/time served (310), up-time (315), wear endurance (320), warranty (325), extended warranty (330), performance (335), workload profiles (340), applications served (345), features employed (350), and in-storage computing performance (355).

5. A device (205, 425, 440) according to claim 1, wherein the partner ID (215, 220) includes a Deployment Partner ID (215) and a Software Partner ID (220), and
the manufacturer (110) can use the metrics (305, 435, 445, 605) and the Deployment Partner ID (215) to provide an incentive (725, 810, 820, 825) to a deployment partner (105) and the metrics (305, 435, 445, 605) and the Software Partner ID (220) to provide an incentive (725, 810, 820, 825) to a software partner (105).

6. A device (205, 425, 440) according to claim 1, wherein:
the storage device (210) includes storage for a Customer ID (225), the Customer ID (225) identifying a customer (125) using the storage device (210); and
the transmitter (235) is operative to transmit the captured metrics (305, 435, 445, 605), the partner ID (215, 220), and the Customer ID (225) to the manufacturer (110),
wherein the manufacturer (110) can use the Customer ID (225) to verify that the storage device (210) is not sold in a grey market.

7. A method, comprising:
capturing (140, 925) metrics (305, 435, 445, 605) using a storage device (210), the storage device (210) deployed for a customer (125) by a partner (105) of a manufacturer (110) of the storage device (210);
accessing (930) a partner ID (215, 220) stored in the storage device (210), the partner ID (215, 220) identifying the partner (105); and
reporting (945) the metrics (305, 435, 445, 605) and the partner ID (215, 220) to the manufacturer (110) of the storage device (210),
wherein the manufacturer (110) can use the metrics (305, 435, 445, 605) and the partner ID (215, 220) to provide an incentive (725, 810, 820, 825) to the partner (105).

8. A method according to claim 7, wherein:
accessing (930) a partner ID (215, 220) includes accessing (930) a Deployment Partner ID (215) and a Software Partner ID (220) stored in the storage device (210), the Deployment Partner ID (215) identifying a deployment partner (105) and the Software Partner ID (220) identifying a software partner (105); and
reporting (945) the metrics (305, 435, 445, 605) and the partner ID (215, 220) to a manufacturer (110) includes reporting (945) the metrics (305, 435, 445, 605), the Deployment Partner ID (215), and the Software Partner ID (220) to the manufacturer (110);
wherein the manufacturer (110) can use the metrics (305, 435, 445, 605) and the Deployment Partner ID (215) to provide an incentive (725, 810, 820, 825) to the deployment partner (105) and the metrics (305, 435, 445, 605) and the Software Partner ID (220) to provide an incentive (725, 810, 820, 825) to the software partner (105).

9. A method according to claim 7, wherein capturing (140, 925) metrics (305, 435, 445, 605) includes receiving (920) a signal from a RAID controller (430) at the storage device (210) to capture the metrics (305, 435, 445, 605).

10. A method according to claim 7, wherein capturing (140, 925) metrics (305, 435, 445, 605) using a storage device (210) includes capturing (140, 925) the metrics (305, 435, 445, 605) using the storage device (210), the metrics (305, 435, 445, 605) drawn from a set including capacity/time served (310), up-time (315), wear endurance (320), warranty (325), extended warranty (330), performance (335), workload profiles (340), applications served (345), features employed (350), and in-storage computing performance (355).

11. A method according to claim 7, wherein reporting (945) the metrics (305, 435, 445, 605) and the partner ID (215, 220) to a manufacturer (110) includes:
reporting (940) the metrics (305, 435, 445, 605) to an aggregator (135),
wherein the aggregator (135) can aggregate the metrics (305, 435, 445, 605) with second metrics (305, 435, 445, 605) from a second storage device (210) before reporting (1020) the aggregated metrics (610) to the manufacturer (110).

12. A method according to claim 7, wherein:
accessing (930) a partner ID (215, 220) stored in the storage device (210) includes accessing (935) a Customer ID (225) stored in the storage device (210), the Customer ID (225) identifying the customer (125); and
reporting (945) the metrics (305, 435, 445, 605) and the partner ID (215, 220) to the manufacturer (110) of the storage device (210) includes reporting (945) the metrics (305, 435, 445, 605), the partner ID (215, 220), and the Customer ID (225) to the manufacturer (110) of the storage device (210),
wherein the manufacturer (110) can use the Customer ID (225) to verify that the storage device (210) is not sold in a grey market.

13. A method, comprising:
receiving (1105) reports (615) from a plurality of customers (125), each report (615) including captured metrics (305, 435, 445, 605) for at least one storage device (210) and a partner ID (215, 220), the partner ID (215, 220) identifying a partner (105) of a manufacturer (110) of the storage device (210);
mining (1120, 1135) the reports (615) to determine if the partner (105) has achieved an objective (730, 805, 815) of an incentive (725, 810, 820, 825); and
if the partner (105) has achieved the objective (730, 805, 815) of the incentive (725, 810, 820, 825), compensating (150, 1125, 1140) the partner (105) according to the incentive (725, 810, 820, 825).

14. A method according to claim 13, wherein:
mining (1120, 1135) the reports (615) includes mining (1120, 1135) the reports (615) to determine if the partner (105) has achieved an objective (730, 805, 815) of each of a plurality of incentives (725, 810, 820, 825); and
compensating (150, 1125, 1140) the partner (105) according to the incentive (725, 810, 820, 825) includes, if the partner (105) has achieved the objective (730, 805, 815) of any of the plurality of incentives (725, 810, 820, 825), compensating (150, 1125, 1140) the partner (105) according to incentives (725, 810, 820, 825) for which the partner (105) has achieved the objective (730, 805, 815).

15. A method according to claim 13, wherein:
receiving (1105) reports includes receiving (1105) the reports (615) from the plurality of customers (125), each report (615) including captured metrics (305, 435, 445, 605) for the at least one storage device (210), a Deployment Partner ID (215), and a Software Partner ID (220), the Deployment Partner ID (215) identifying a deployment partner (105) of the manufacturer (110) of the storage device (210) and the Software Partner ID (220) identifying a software partner (105) of the manufacturer (110) of the storage device (210);
mining (1120, 1135) the reports (615) includes:
mining (1120) the reports (615) to determine if the deployment partner (105) has achieved an objective (730, 805, 815) of a first incentive (725, 810, 820, 825); and
mining (1135) the reports (615) to determine if the software partner (105) has achieved an objective (730, 805, 815) of a second incentive (725, 810, 820, 825); and
compensating (150, 1125, 1140) the partner (105) according to the incentive (725, 810, 820, 825) includes:
if the deployment partner (105) has achieved the objective (730, 805, 815) of the first incentive (725, 810, 820, 825), compensating (150, 1125) the deployment partner (105) according to the first incentive (725, 810, 820, 825); and
if the software partner (105) has achieved the objective (730, 805, 815) of the second incentive (725, 810, 820, 825), compensating (150, 1140) the software partner (105) according to the second incentive (725, 810, 820, 825).

16. A method according to claim 13, wherein compensating (150, 1125, 1140) the partner (105) according to the incentive (725, 810, 820, 825) includes providing (1130, 1145) the partner (105) with use-case information regarding the storage devices (210).

17. A method according to claim 13, wherein:
receiving (1105) reports includes receiving (1105) the reports (615) from a plurality of customers (125), each report (615) including captured metrics (305, 435, 445, 605) for at least one storage device (210), a partner ID (215, 220), and a Customer ID (225), the Customer ID (225) identifying a customer (125) for whom the at least one storage device (210) was deployed; and
mining (1120, 1135) the reports (615) includes mining (1170) the reports (615) to determine if any storage device (210) has entered a grey market.

18. A method according to claim 13, further comprising:
mining (1120, 1135) the reports (615) includes mining (1155) the reports (615) to determine an operative status of the at least one storage device (210); and
if the operating status of the at least one storage device (210) indicates the at least one storage device (210) requires maintenance, providing (1165) preventative maintenance to the at least one storage device (210).

19. A method, comprising:
receiving (1105) reports (615) from a plurality of customers (125), each report (615) including captured metrics (305, 435, 445, 605) for at least one storage device (210) and a partner ID (215, 220), the partner ID (215, 220) identifying a partner (105) of a manufacturer (110) of the storage device (210);
mining (1170) the reports (615) to determine if any storage device (210) has entered a grey market; and
penalizing (1205) the partner (105) for permitting the storage device (210) to enter the grey market.

20. A method according to claim 19, further comprising disabling (1210) the storage device (210).
